(19) United States
(12) Patent Application Publication
(10) Pub. No.: US 2021/0385674 A1
(43) Pub. Date: Dec. 9, 2021

(54) DIGITAL RADIO TRANSMISSIONS

(71) Applicant: Nordic Semiconductor ASA, Trondheim (NO)

(72) Inventors: Audun Korneliussen, Trondheim (NO); Jon Helge Nistad, Trondheim (NO)

(73) Assignee: Nordic Semiconductor ASA, Trondheim (NO)

(21) Appl. No.: 16/896,921

(22) Filed: Jun. 9, 2020

(51) Int. Cl. H04W 24/08; H04W 4/80; H04L 1/20

(52) U.S. Cl. CPC H04W 24/08; H04L 1/20; H04W 4/80

(57) ABSTRACT

A digital radio communication system comprises a central device and a peripheral device arranged to operate in accordance with a predetermined communication protocol. The central and peripheral devices are both arranged to: transmit data packets over a plurality of available radio channels having different frequencies; receive the data packets transmitted by the other respective device; and perform data integrity checks on the data packets received. At least one of the central and peripheral devices is arranged to assign a dynamic channel rating to one or more of said radio channels based on an outcome of at least some of the data integrity checks.

### FIELD

This invention relates to short-range, ad hoc radio communication networks and in particular to improving the reliability of communications therein. Such networks, which include for example Bluetooth™, have many uses for transferring data between, and controlling, a whole variety of devices.

### BACKGROUND

The Bluetooth™ Low Energy (BLE) protocol defines a number of different radio frequency (RF) channels, each comprising a band of frequencies, that data may be sent over. When in a data connection with a peripheral device, a central device utilises a frequency hopping algorithm to cycle through the different RF data channels available in the connection. In BLE there are 37 different RF data channels available in the 2.4 GHz public ISM band. Frequency hopping provides a robust method for maintaining a connection when in the presence of interference, as no one RF data channel is relied upon for data transfer.

BLE devices may be configured to ‘hop’ between all 37 different channels whilst in a data connection with a peripheral.

Equally however devices may employ a channel map from which the RF channels that the device will use during frequency hopping are selected. This might be used for example in a device which supports multiple radio protocols to ensure that channel hopping does not use channels which would interfere with the other protocol being used on the device.

### SUMMARY

When viewed from a first aspect, the present invention provides a digital radio communication system comprising a central device and a peripheral device arranged to operate in accordance with a predetermined communication protocol, wherein the central and peripheral devices are both arranged to:
transmit data packets over a plurality of available radio channels having different frequencies;
receive the data packets transmitted by the other respective device; and
perform data integrity checks on the data packets received; wherein at least one of the central and peripheral devices is arranged to assign a dynamic channel rating to one or more of said radio channels based on an outcome of at least some of the data integrity checks.

Thus it will be understood by those skilled in the art that the present invention provides the ability for a radio transceiver to keep track of which particular channels are suffering from interference so that, for example those channels can be used less or not at all for subsequent transmissions. Moreover as the rating is based on standard data integrity checks, e.g. cyclic redundancy checks (CRCs), no additional radio time is required as would be the case for Received Signal Strength Indicator (RSSI) scanning or transmission of dedicated test packets, or additional overhead on the radio link as would be required for channel quality metadata. Devices in accordance with the invention are able to assess channel quality during normal operation, with data packets and acknowledgements which are sent back and forth between a central and peripheral device as a part of normal operation.

It will be further appreciated by those skilled in the art that by dynamically assigning the channel ratings, embodiments of the invention can adapt to changing conditions and can obviate the need to set up devices supporting multiple protocols in advance in order to avoid collisions.

When viewed from a second aspect, the present invention provides a digital radio transceiver arranged to operate in accordance with a predetermined communication protocol, wherein the transceiver is arranged to:
transmit data packets over a plurality of available radio channels having different frequencies;
receive data packets transmitted by another digital radio transceiver;
perform data integrity checks on the data packets received; and
assign a dynamic channel rating to one or more of said radio channels based on an outcome of at least some of the data integrity checks.

When viewed from a third aspect, the present invention provides a method of operating a digital radio communication system comprising a central device and a peripheral device in accordance with a predetermined communication protocol, the method comprising:
both devices transmitting data packets over a plurality of available radio channels having different frequencies;
both devices receiving the data packets transmitted by the other respective device;
both devices performing data integrity checks on the data packets received; and
at least one of the central and peripheral devices assigning a dynamic channel rating to one or more of said radio channels based on an outcome of at least some of the data integrity checks.

When viewed from a fourth aspect, the present invention provides a method of operating a digital radio transceiver in accordance with a predetermined communication protocol, the method comprising:
transmitting data packets over a plurality of available radio channels having different frequencies;
receiving data packets transmitted by another digital radio transceiver;
performing data integrity checks on the data packets received; and
assigning a dynamic channel rating to one or more of said radio channels based on an outcome of at least some of the data integrity checks.

When viewed from a fifth aspect, the present invention provides a non-transitory computer readable medium comprising instructions to cause a digital radio transceiver to operate in accordance with the method outlined above.

In a set of embodiments, the central and peripheral devices are further arranged to:
transmit an acknowledgment packet when a data packet is received and the data integrity check passes; and
either transmit a negative acknowledgement packet or transmit no response when a data packet is received but the data integrity check fails.

In a set of embodiments, the at least one of the central and peripheral devices is arranged to assign a dynamic channel rating to each channel by improving the rating each time a data integrity check performed on a received packet is passed and deteriorating the rating each time a data integrity check performed on a received packet is failed.

The ratings could simply be retained for each channel until a data integrity check next passes or fails on that channel. The Applicant has recognised however that in some circumstances (e.g. in a high latency application) there could be a relatively long time between packets being received over certain channels such that the ratings associated with those channels become out of date or ‘stale’ because channel conditions have changed. In a set of embodiments, the at least one of the central and peripheral devices is further arranged to degrade the rating assigned to at least some channels which have not been improved or deteriorated based on data integrity checks for at least a predetermined interval. The corresponding ratings for such channels, or optionally for all channels, could be deteriorated by a fixed amount, a fixed factor or any other appropriate formula. In a set of such embodiments each channel rating is multiplied by a predetermined value between 0 and 1 at a predetermined interval. In doing this, the ratings of channels over which few or no packets are received degrade over time so that they do not unduly influence more up to date assessments of other channels—e.g. where averages are used as in accordance with some embodiments.

In a set of embodiments, the at least one of the central and peripheral devices is further arranged to reduce the usage of radio channels based on their channel rating. Whilst it is envisaged that a sliding scale could be employed such that usage is biased towards channels with a better rating and away from those with a worse rating, more preferably, the at least one of the central and peripheral devices is arranged to remove radio channels from a channel map, based on their channel ratings. The term channel map, as used herein, refers to the selection of radio channel frequencies a central and peripheral device will transmit/receive data packets over and is typically (e.g. in BLE) communicated by the central device to the peripheral.

In a set of embodiments, the central and peripheral devices are arranged to frequency hop between the radio channels provided in the channel map according to a predetermined algorithm. As used herein, the term frequency hop refers to a central and peripheral device regularly changing the radio channel frequency that data packets are transmitted on in order to avoid interference and prevent eavesdropping. The frequency hopping algorithm may be communicated between the central and peripheral device during connection establishment. Radio channels that are removed from the channel map are thus not used so that the central and peripheral device do not transmit or receive data packets over these channels during the frequency hopping process.

The at least one of the central and peripheral devices may be arranged to compare channels ratings to an absolute threshold and to remove radio channels with poorer ratings than the threshold. In a set of embodiments however the rating of a given channel is compared to an average rating of at least some and preferably all of the radio channels currently in use. The central and/or peripheral device could be arranged to remove all channels that are worse than the average by a predetermined amount (either in absolute or percentage terms) or a maximum number of those that are worst.

In a set of embodiments, the at least one of the central and peripheral devices is arranged to assess each channel's rating at a recurring interval, which may be defined in terms of time or in terms of a number of packets received. In a set of embodiments, the at least one of the central and peripheral devices is arranged to:
calculate an average channel rating of all of the radio channels in a channel map;
compare the rating of each individual channel to the average channel rating; and
remove at least one channel having a rating worse that the average channel rating by a predetermined amount from the channel map.

In a set of embodiments, the at least one of the central and peripheral devices is further arranged to modify the rating of one or more channels based on the ratings of channels within a predetermined range of frequencies around said channel. If one channel experiences high levels of interference, it is likely that channels of similar frequencies will also experience interference due to the wide frequency bands of common interference sources. Advantageously, this allows the ratings of a radio channel to be updated by considering the ratings of channels of similar frequencies, even when no packets are being transmitted or received over said channel and thus little direct information about the quality of said channel may be obtained.

The Applicant has recognised that a significant reason for interference arises if one of the devices—or another device in the immediate vicinity—is operating another radio protocol which employs frequencies which overlap those used in the protocol in accordance with the invention. By following the approach outlined above of assessing the implication for additional channels based on the ratings for a smaller number of channels, the impact of another protocol operating at the same time can be better accommodated as it does not rely on waiting to build up a complete picture through the impact on the ratings for all the channels affected. One way of doing this which the Applicant has devised is to identify one or more potentially interfering channels of another radio protocol and to assign a dynamic activity rating thereto based on the channel ratings or data integrity checks on channels associated with the potentially interfering channel(s) according to a predetermined association. Other radio protocols may use considerably wider frequency bands than those used in accordance with the invention, thus a single channel of another radio protocol may have a frequency band that overlaps (and therefore interferes) with several channels of the predetermined communication protocol. Typically therefore the other radio protocol comprises channels which are wider than the predetermined communication protocol.

Thus in a set of embodiments, the at least one of the central and peripheral devices is further arranged to assign a dynamic activity rating to one or more potentially interfering channels based on the channel ratings of, or data integrity checks on, channels associated with the potentially interfering channel(s) according to a predetermined association. The central and/or peripheral devices may therefore determine whether or which one(s) of the other known and potentially interfering radio protocol channels is/are active based on the activity ratings assigned to them. This may then be used to remove all of the radio channels associated with the potentially interfering channel if the activity rating reaches a threshold. In a set of embodiments, the potentially interfering channels are Wi-Fi channels, i.e. those specified in IEEE 802.11.

In a set of embodiments, assigning a dynamic activity rating to a potentially interfering channel comprises:
calculating a first average channel rating of the radio channels that are associated with the potentially interfering channel,
calculating a second average channel rating of all or the remaining radio channels currently in use; and
comparing the first average channel rating to the second average channel rating.

The comparison of averages could be used to strengthen or weaken an activity rating. For example the corresponding activity rating could be strengthened if the first average is worse than the second average by more than a first predetermined amount. The activity rating could be weakened if the first average is worse than the first average by less than a second amount or better than the second average. The first and second amounts need not be identical but could be. The activity rating could be strengthened and/or weakened by a fixed amount but in a set of embodiments it is strengthened and/or weakened by an amount dependent on one or more of: the first average, the difference between the first and second averages; or the channel rating of a radio channel associated with the potentially interfering channel.

As described above in relation to the radio channel ratings, the activity ratings could simply be retained until updated information is received but for similar reasons in a set of embodiments, the at least one of the central and peripheral devices is further arranged to degrade the activity rating assigned to at least one potentially interfering channels which has not been strengthened or weakened for at least a predetermined interval. The corresponding activity ratings for such channels could be deteriorated by a fixed amount, a fixed factor or any other appropriate formula. In a set of such embodiments each activity rating is multiplied by a predetermined value between 0 and 1 at a predetermined interval.

In a set of embodiments, the central device assigns the channel ratings. This could be based just on the data integrity checks it performs or the peripheral device may be arranged to transmit data indicative of the outcomes of the data integrity checks it performs locally, to the central device. Where the peripheral device assigns channel ratings, the peripheral device may be arranged to transmit data packets indicative of the channel ratings applied to each channel to the central device. In a set of embodiments, both of the central and peripheral devices assign channel ratings and the central device may take the channel ratings assigned by both devices into account in determining changes to the channel map.

In a set of embodiments, central and/or peripheral device is arranged to re-evaluate radio channels that have been removed from the channel map after a predetermined interval (e.g. length of time or number of packets received) by returning such channels to the channel map. This further provides for updating the channel map dynamically as channel conditions change—e.g. if a source if interference is no longer present. All channels meeting the interval criterion could be re-introduced or the number could be limited. Where channels have been removed in accordance with embodiments of the invention through the potentially interfering channel activity rating, all of the associated radio channels could be re-introduced but in a set of embodiments only one or more representative channels associated with the potentially interfering channel is re-introduced. The representative channel could, for example, be one that is closest to a centre frequency of the potentially interfering channel.

In a set of embodiments, the data integrity checks comprise cyclic redundancy checks (CRCs). Alternatively, the data integrity checks may comprise checksums, or any other form of data integrity check as is known in the art.

### BRIEF DESCRIPTION OF THE DRAWINGS

An embodiment of the invention will now be described, by way of example only, with reference to the accompanying drawings in which:

FIG. 1 is a schematic diagram illustrating a typical radio communication system;

FIG. 2 is a schematic diagram illustrating a low-level packet structure of a data packet in accordance with the present invention;

FIG. 3 is a schematic diagram illustrating an example of different Radio Frequency (RF) channels available to devices in accordance with the present invention, as well as typical interfering Wi-Fi channels;

FIG. 4 is a schematic diagram illustrating a typical packet transmission/reception scenario with different data integrity check outcomes in accordance with the present invention;

FIG. 5 is a flowchart illustrating the process by which a device may update dynamic channel ratings to individual RF channels in accordance with the present invention;

FIG. 6 is a flowchart illustrating the process by which a device may detect interfering Wi-Fi channels in accordance with the present invention;

FIG. 7 is a graph illustrating an example of typical channel ratings as may be determined by a device in accordance with the present invention; and

FIG. 8 is a flowchart illustrating the process by which a device may blacklist and re-evaluate channels according to the dynamic channel rating assigned to each.

### DETAILED DESCRIPTION OF THE DRAWINGS

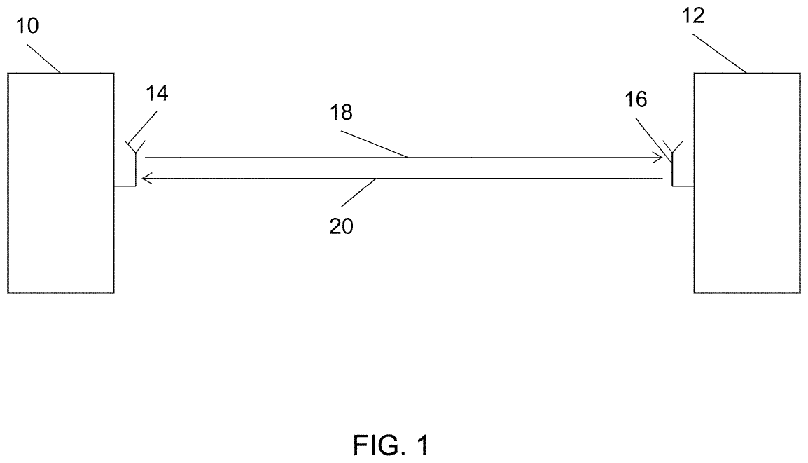

FIG. 1 shows a radio system comprising a central radio transceiver device 10 operating in accordance with the Bluetooth Low Energy™ radio protocol and a peripheral radio transceiver device 12 also operating in accordance with Bluetooth Low Energy™. Hereafter, these will be referred to as the central device 10 and peripheral 12. The central device 10 comprises an antenna 14 and the peripheral 12 comprises an antenna 16. As will also be well understood by those skilled in the art, a number of standard modules such as processors, oscillators, filters, amplifiers, digital to analogue converters (DACs) and analogue to digital converters (ADCs) are provided in the radio transceivers 10 and 12 but the description of these is omitted for the sake of brevity.

FIG. 1 also shows the signal paths 18 and 20 of the Bluetooth Low Energy™ radio signals. Signal path 18 is from the central device 10 when acting as a transmitter through its antenna 14 to the peripheral 12 when acting as a receiver through its antenna 16. Signal path 20 is from the peripheral 12 when acting as a transmitter through its antenna 16 to the central device 10 when acting as a receiver through its antenna 14.

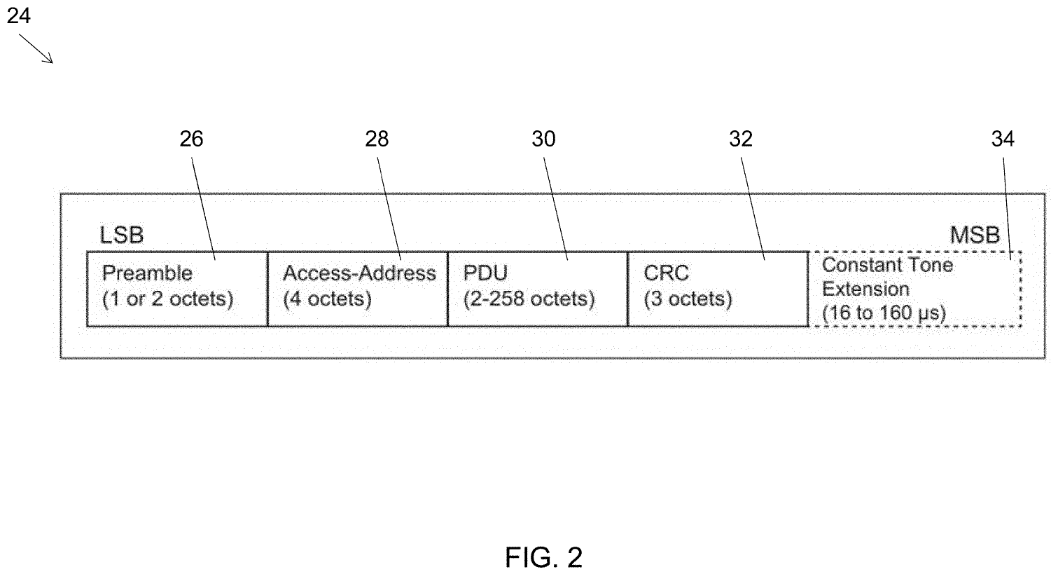

FIG. 2 shows an example low level structure of a data packet 24 in accordance with the present invention. Each data packet transmitter by either the central device 10 or the peripheral 12, when acting as a transmitter, will have the packet structure 24. The structure of the data packet 24 is known in the art and taken directly from the Bluetooth Core Specification Document, Version 5.2|Vol. 6, Part B, Section 2.1.

The data packet 24 comprises a 1-2 octet (8-16 bit) long Preamble 26; a 4 octet (32 bit) long Access-Address 28; a 2-258 octet (16-2064 bit) long Protocol Data Unit (PDU) 30; a 3 octet (24 bit) long Cyclic Redundancy Check 32; and a Constant Tone Extension (CTE) 34 lasting 16-160 μs. As will be understood by those skilled in the art, the Least Significant Bit (LSB) of the packet is the first bit transmitted and the Most Significant Bit (MSB) of the packet is the final bit transmitted.

The Preamble 26 is used for synchronisation and timing estimation at the receiver. The Access Address 28 comprises a (typically) unique sequence of bits to identify the connection, allowing a receiver to distinguish between data packets received from connections to different devices. The PDU 30 comprises the payload of the data packet, including the data intended for transmission and necessary side information required to decode it, e.g. PDU type, whether or not the transmitter's address is public or random, etc. The CRC 32 is used to ensure data integrity for each packet transmitted, as will be described in further detail below. The CTE 34 is a pure tone (e.g. a continuous stream of binary 1s) that is transmitted such that a receiver can gather IQ (In-Phase/Quadrature) data without measurements being disrupted by modulation.

When a data packet 24 is received by either the central 10 or peripheral 12, the receiving device will perform a data integrity check using the received CRC 32. As will be understood by those skilled in the art, the transmitting device will calculate the CRC 32 of the data packet using a predetermined algorithm based on the exact sequence of bits in the portions of the packet preceding the CRC 32, before transmitting it as a twenty-four-bit binary number. The receiver, when it receives the packet, will locally calculate the CRC 32 for the specific sequence of bits received, not including the received CRC 32, using the same predetermined algorithm as the transmitter. If the CRC 32 generated locally by the receiver matches the received CRC 32, this means that the data integrity check has passed—i.e. the data that was transmitted is highly likely to be identical to the data that was received. Using the CRC 32 in this way provides the ability for a receiver to efficiently check if any data was lost/corrupted during transmission of a data packet.

In accordance with the present invention, the central 10 and peripheral 12 are arranged to transmit data packets 24 to each other over a plurality of radio frequency (RF) data channels. As defined in the BLE specification, the devices 10, 12 transmit data packets using a frequency hopping algorithm wherein the devices change the carrier frequency at which each data packet 24 is transmitted according to a pre-determined algorithm. The specific frequency hopping algorithm used is determined by the central 10 in accordance with the BLE specification and communicated to the peripheral 12 during connection establishment. Frequency hopping helps provide a robust method for maintaining a connection when the central 10 and peripheral 12 are located in the presence of other RF interference, as no one RF data channel is solely relied upon for data transfer.

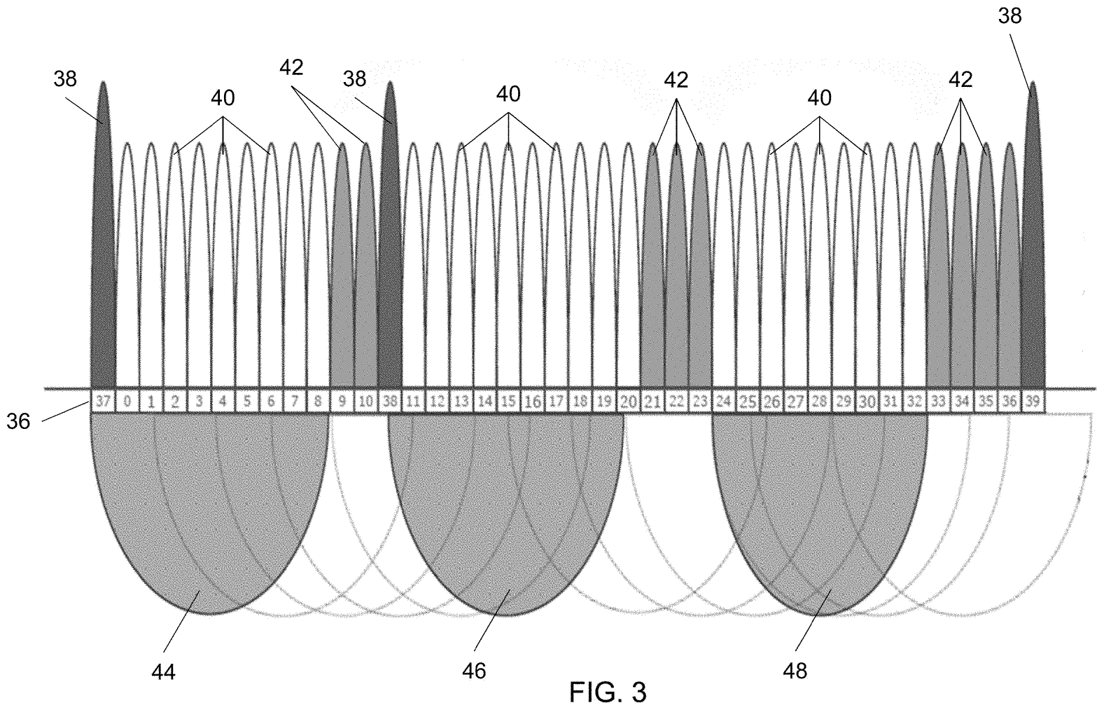

FIG. 3 shows a diagram of example RF channels available to the central 10 and peripheral 12 in accordance with the present invention, as well as typical interfering Wi-Fi channels. The upper half of the diagram shows forty different RF channels available to the central 10 and peripheral 12, each denoted by an index 36. Each channel has a specific frequency band between 2.4 and 2.480 GHz. Advertising channels 38 are used to initiate connections between the central 10 and peripheral 12 and data channels 40, 42 are used to transmit data packets between the central 10 and peripheral 12 once a connection has been formed. There are three advertising channels 38 and thirty-seven data channels 40, 42 available to the central and peripheral. In this example, the RF channels 38, 40 and 42 are Bluetooth Low Energy (BLE) channels.

The lower half of the diagram shows three common Wi-Fi channels 44, 46 and 48 (e.g. those having indices of one, six and eleven) which have frequency ranges that in theory overlap with some of the BLE channels 40 leaving only a few of the BLE data channels 42 which do not overlap. It will be understood by those skilled in the art that interfering channels are not limited to the Wi-Fi channels with frequency bands shown in FIG. 3, but may be any channels with frequency bands which overlap with BLE channels 38, 40 and 42. For example, the minimum width of an interfering channel may be 22 MHz, and the maximum width may be much greater, thus each interfering channel will overlap with a greater number of BLE channels 38, 40 and 42.

In practice each BLE data channel 40, 42 will experience a different amount of interference dependent on the physical location of the central 10 and peripheral 12, the local environment and what other RF channels (such as the Wi-Fi channels 44, 46, 48) are in use in the local area. It is therefore desired that a central 10 and peripheral 12 are able to determine which BLE data channels 40, 42 are performing well and which are not, so that the devices may avoid using poor quality data channels.

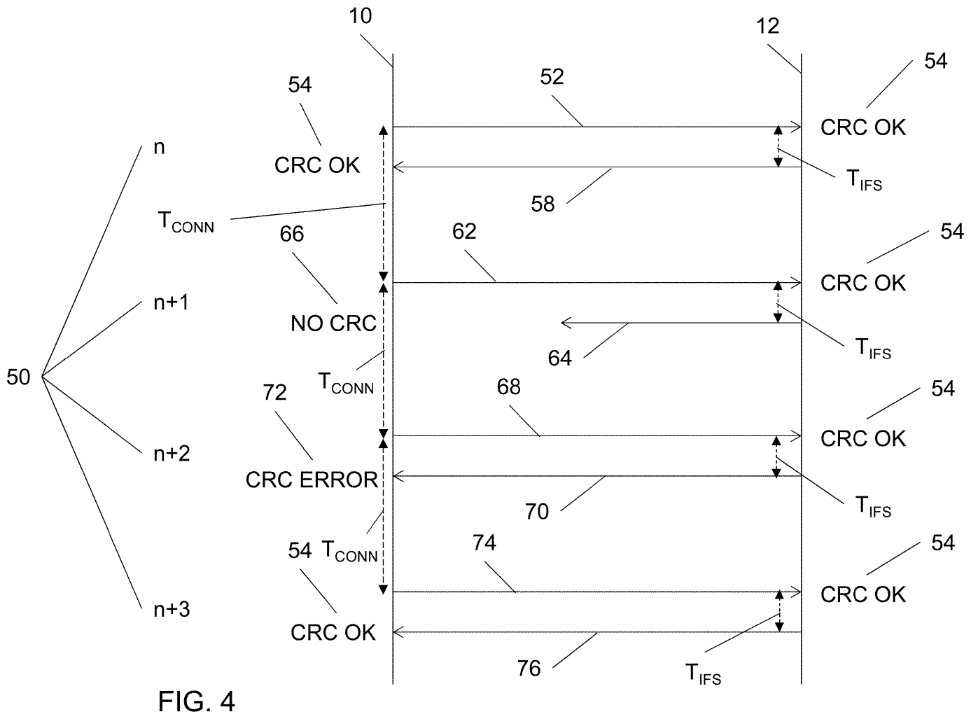

FIG. 4 shows an example data packet transmission and reception sequence between the central 10 and peripheral 12 over multiple different channels 50. When a packet is transmitted by one of the central 10 or peripheral 12, there are three possible outcomes of the Cyclic Redundancy Check at the receiver end—either the CRC passes (CRC OK 54), the CRC fails (CRC ERROR 72) or no packet is received in which case no CRC is received (NO CRC 66).

Initially, the central 10 transmits a first data packet 52 over channel n, which is one of the BLE channels 40, 42 chosen from a channel map determined, according to a predetermined algorithm, by the central device 10 and communicated to the peripheral device 12 during connection establishment. The data packet 52 is then received by the peripheral 12 which determines CRC OK 54, indicating that the packet was successfully received. It will be understood by those skilled in the art that channel n does not refer to the channel of index n, but instead refers to the channel used by the central 10 and peripheral 12 on the n^{th} iteration of the frequency hopping algorithm. After receiving the first data packet 52, the peripheral 12 sends a first reply packet 58 over channel n a period of T_{IFS} later. The period T_{IFS} is specified by the predetermined communication protocol, and in this example is equal to 150 μs. The central 10 receives the first reply packet 58 and determines CRC OK 54, indicating the reply packet was successfully received.

The packet exchange between the central 10 and peripheral 12 follows a polling style pattern, wherein the central 10 transmits a packet once per regular interval T_{CONN}. The interval T_{CONN} is specified during connection establishment between the central 10 and peripheral 12, and is generally fixed for the duration of the connection, though there exists a handshake protocol for changing its value whilst the central 10 and peripheral 12 are connected. In this example, the value of the interval T_{CONN} lies between 7.5 ms and 4 s and has a tolerance of ±16 μs.

As the first data packet 52 and first reply packet 58 were transmitted and received successfully, the central transmits a second data packet 62 over channel n+1 one interval T_{CONN} after transmitting the first data packet 52. The second data packet 62 is then received by the peripheral 12 which determines CRC OK 54, indicating that the packet was successfully transmitted and received. It will be understood by those skilled in the art that channel n+1 does not refer to the channel of index one higher than channel n, instead it refers to the channel used by the central 10 and peripheral 12 on the n+1^{th} iteration of the frequency hopping algorithm, and will therefore be the next of the data channels 40, 42 in the channel map and specified by the channel hopping algorithm. After receiving the second data packet 62, the peripheral 12 sends a second reply packet 64 over channel n+1 a period of T_{IFS} later. The second reply packet 64, however, is not in this instance received by the central 10, as a result of increased interference or attenuation on channel n+1. As the central 10 expects to receive a response a period of T_{IFS} after transmitting the second data packet 62, but none is received, the central 10 determines NO CRC 66.

As the second reply packet 64 was not received by the central 10, the central 10 transmits a retry 68 of the second data packet 62 over channel n+2 one interval T_{CONN} after transmitting the second data packet 62. The retry packet 68 is then received by the peripheral 12 which determines CRC OK 54, indicating that the packet was successfully received. After receiving the retry packet 68, the peripheral 12 sends a third reply packet 70 over channel n+2 a period of T_{IFS} later. Although the third reply packet 70 is received by the central 10, the central 10 determines CRC ERROR 72, indicating that the packet received by the central 10 differed from the third reply packet 70 transmitted by the peripheral 12, and thus the CRC check failed.

As the third reply packet 70 was not successfully received by the central 10, the central 10 transmits a second retry 74 of the second data packet 62 over channel n+3 one interval T_{CONN} after transmitting the first retry packet 68. The second retry packet 74 is then received by the peripheral 12 which determines CRC OK 54, indicating that the packet was successfully transmitted and received. After receiving the second retry packet 74, the peripheral 12 sends a fourth reply packet 76 over channel n+3 a period of T_{IFS} later. The central 10 receives the fourth reply packet 76 and determines CRC OK 54, indicating the packet was successfully received. The central 10 will continue to transmit further data packets, with limited retries if necessary, for the duration of the connection between the central 10 and the peripheral 12, and the peripheral 12 will continue to transmit response packets.

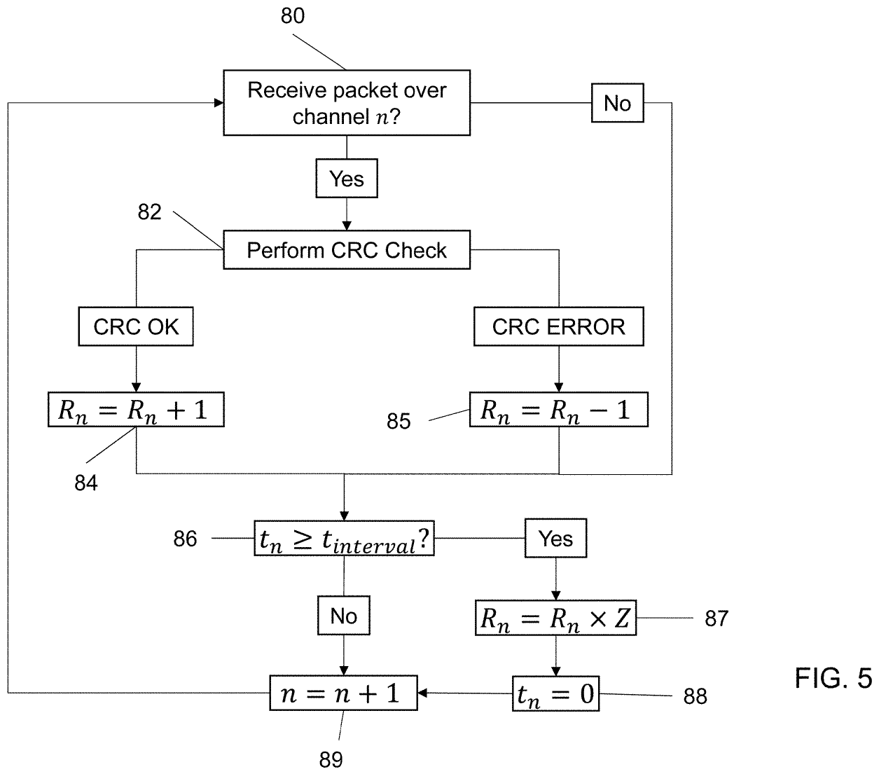

The process by which the central device 10 assigns dynamic channel ratings to each BLE channel and each Wi-Fi channel, in accordance with the present invention, will now be described with reference to FIGS. 5 to 7. FIG. 5 shows a flowchart of the process of assigning a dynamic channel rating to each BLE channel based on packet reception, as performed by the central device 10.

At step 80, the central device 10 listens over BLE channel n. The selection of channel being used is made according to a predetermined channel hopping algorithm and a channel map which is communicated by the central device 10 to the peripheral device 12 during connection establishment and which is periodically updated. The channel map is discussed in greater detail below. If no data packet is received over channel n within the expected time of T_{IFS}±2 μs the central device 10 proceeds to step 88, where it proceeds to the next iteration n=n+1 of the frequency hopping algorithm and returns to step 80. As explained earlier, it will be understood by those skilled in the art that channel n+1 does not refer to the channel of index one higher than channel n, instead it refers to the channel used by the central 10 and peripheral 12 on the n+1^{th} iteration of the frequency hopping algorithm, and therefore may be any other of the data channels 40, 42 available to the central 10 and peripheral 12.

If a data packet is received from the peripheral 12 within the expected time [?], the central device 10 proceeds to step 82, where it performs a CRC check on the received data packet, as is known in the art. If the outcome of the CRC check is CRC OK, the central device 10 proceeds to step 84, where it increments the dynamic channel rating Rₙ assigned to channel n by one. If the outcome of the CRC check is CRC ERROR, the central device 10 proceeds to step 85, where it decrements the dynamic channel rating Rₙ by one. It will be understood by those skilled in the art that the value each dynamic channel rating Rₙ is incremented or decremented by is not limited to one, but may be any number. For example, the central 10 may assign different weights to different CRC outcomes by incrementing Rₙ by a larger or smaller value when the outcome is CRC OK than the value it decrements Rₙ by when the outcome is CRC ERROR. In this example, the starting values for the dynamic channel ratings Rₙ of each channel are equal. It will be understood by those skilled in the art that the starting values of the dynamic channel ratings Rₙ for each channel may be any number, as the channel rating Rₙ is unitless and only serves to act as a numerical comparison of channel quality between different BLE channels.

The central device 10 then proceeds to step 86, where it begins the BLE channel rating degradation process. First, at step 86, the central device 10 determines the time tₙ since the channel rating Rₙ was last degraded for channel n. If the time since the last degradation tₙ is greater or equal to configurable interval tᵢₙₜₑᵣᵥₐₗ, the central device 10 proceeds to step 87, where it degrades the channel rating Rₙ by a configurable value Z according to the equation:

Rₙ=Rₙ×Z, (1)

wherein 0<Z<1, before proceeding to step 88 where it resets the time tₙ since the last degradation for channel n back to zero. The central device 10 then proceeds to step 89, where it proceeds to the next iteration n=n+1 of the frequency hopping algorithm. The central device then returns to step 80.

If, at step 86, the central device 10 determines that tₙ<tᵢₙₜₑᵣᵥₐₗ, the central device instead proceeds directly to step 89 where it proceeds to the next iteration n=n+1 of the frequency hopping algorithm. The central device then returns to step 80.

By performing the BLE channel degradation process outlined above, the channel ratings Rₙ of channels over which few data packets are received decrease over time when no packets are received—be it as a result of the peripheral 12 not transmitting data packets over these channels or as a result of increased attenuation or interference on these channels preventing successful packet reception by the central device 10.

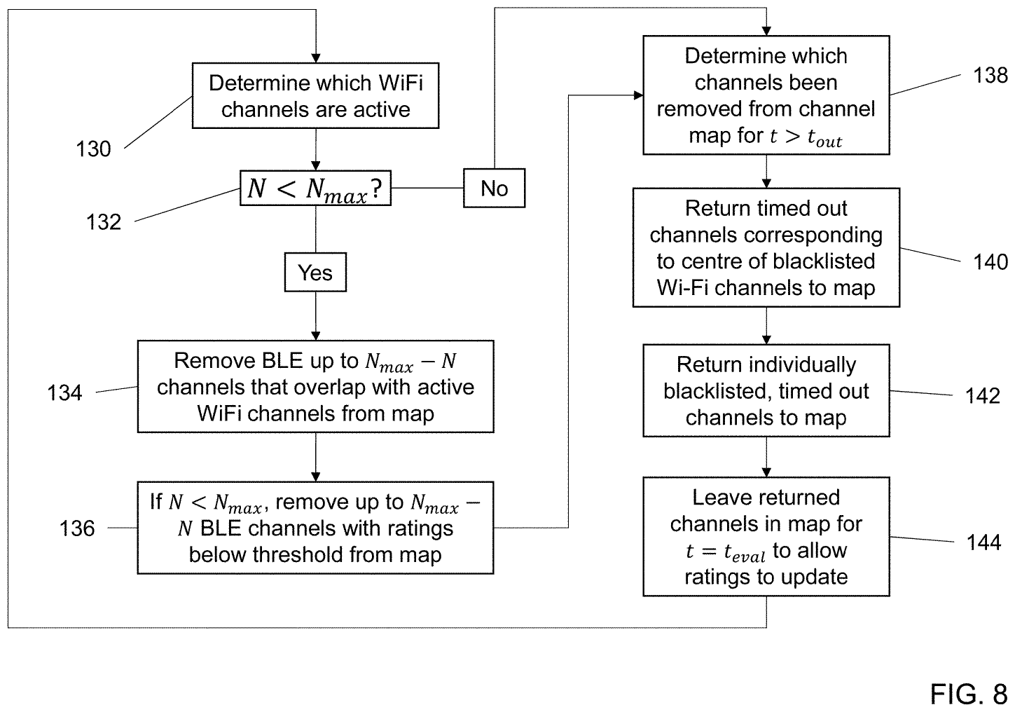

The dynamic channel ratings applied to each channel are used by the central device 10 to determine which channels should be removed from the channel map—i.e. no longer used for transmissions—as will be described in further detail later on with reference to FIG. 8.

It will be understood by those skilled in the art that although in this example it is the central device 10 that assigns the dynamic channel ratings Rₙ, in other embodiments the peripheral device 12 could assign dynamic channel ratings using a similar process and communicate their values to the central device 10 via suitable control channel packets.

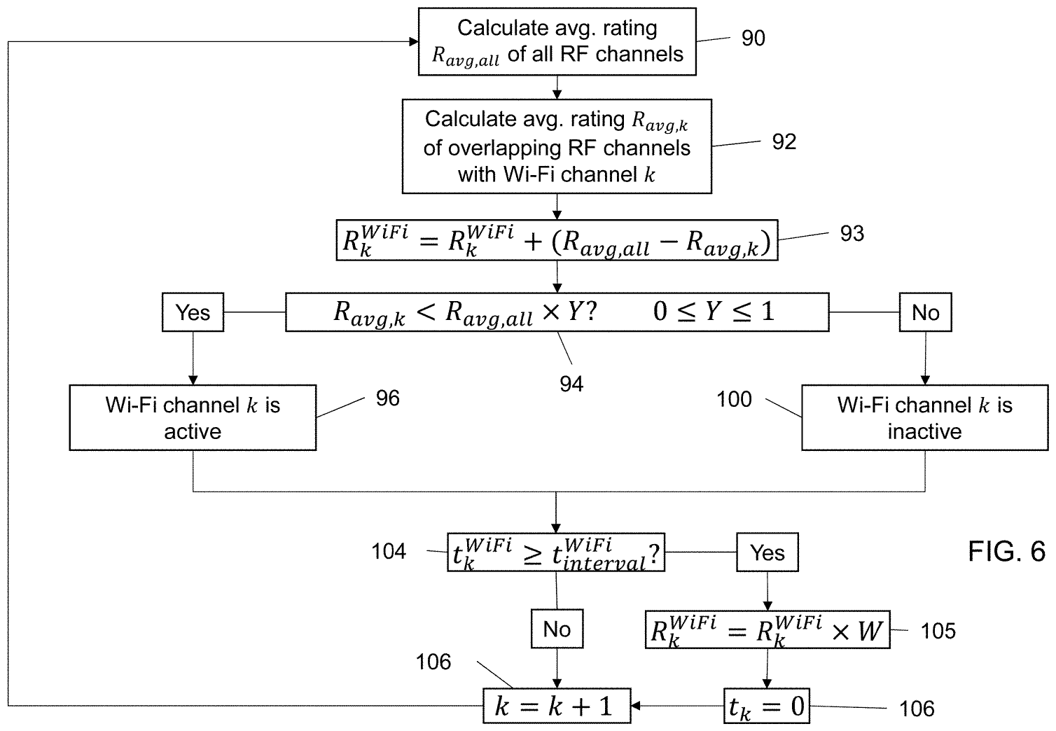

FIG. 6 shows a flowchart of the process of detecting active Wi-Fi channels that are known to have frequency bands that overlap with the range of frequencies the central 10 and peripheral 12 devices are arranged to operate within. As is shown in FIG. 3, there are numerous Wi-Fi channels 44, 46, 48 with frequency bands that overlap with BLE channels 40 available to the central 10 and peripheral 12, and as such if those Wi-Fi channels are in use in close proximity to the central 10 and peripheral 12 then it is probable that these BLE channels 40 will experience increased interference. As a result, it is likely that fewer packets will be successfully transmitted (i.e. transmitted, received and CRC check passed) over the overlapping BLE channels 40 and therefore in accordance with the operation set out above, their dynamic channel rating would eventually be lowered. However by implementing the operation set out below, this process is made more efficient by exploiting knowledge of which BLE channels 40 the Wi-Fi channels 44, 46, 48 potentially interfere with. This association is stored by the central device 10 in the form of a look-up table,

At step 90 the central device 10 calculates the average (mean) rating R_{avg,all} of all BLE channels 40, 42 currently in use according to the channel map. The central 10 then proceeds to step 92, where it calculates the average (mean) rating R_{avg,k} of the BLE channels 40 that are associated with (i.e. have frequency bands that overlap) known Wi-Fi channel k. It will be understood by those skilled in the art that the Wi-Fi channel k refers to the Wi-Fi channel of the k^{th} iteration of the dynamic Wi-Fi channel rating assignment process and not necessarily the Wi-Fi channel of index k.

At step 93, the central device 10 increments the dynamic Wi-Fi channel activity rating Rₖ^{WiFi} by R_{avg,all}−R_{avg,k}, thus the dynamic Wi-Fi channel activity rating Rₖ^{WiFi} is a dynamically sized inverse to the average channel rating R_{avg,k} of the overlapping BLE channels 40. It will be understood by those skilled in the art that if R_{avg,k}>R_{avg,all}, the Wi-Fi channel activity rating Rₖ^{WiFi} will be decremented, instead of incremented, by the magnitude of the difference between R_{avg,all} and R_{avg,k}. A higher value of the dynamic Wi-Fi channel activity rating Rₖ^{WiFi} therefore indicates that the Wi-Fi channel is active and so likely to cause interference with overlapping BLE channels. Conversely, a lower value of the dynamic Wi-Fi channel activity rating Rₖ^{WiFi} indicates that the Wi-Fi channel is inactive and may therefore not cause interference with overlapping BLE channels. In this example, the starting values for the dynamic Wi-Fi channel activity ratings Rₖ^{WiFi} of each channel are equal. The starting values of the dynamic Wi-Fi channel ratings Rₖ^{WiFi} for each channel may be any number, as the Wi-Fi channel activity rating Rₖ^{WiFi} is unitless and only serves to act as a numerical comparison of the activity on different Wi-Fi channels.

The central device 10 then proceeds to step 94, where it compares the values of R_{avg,k} and R_{avg,all}. The central 10 determines if

R_{avg,k}<R_{avg,all}×Y, (2)

wherein Y is a configurable value and 0<Y<1, i.e. the central device 10 determines if the average rating R_{avg,k} of the BLE channels that overlap with Wi-Fi channel k is less than a configurable proportion of the average rating R_{avg,all} of all of the BLE channels currently in use. If this is the case, then the central 10 proceeds to step 96, where it determines that Wi-Fi channel k is active. If, instead, the central device 10 determines that R_{avg,k}≥R_{avg,all}×Y, it proceeds to step 100, where it determines that Wi-Fi channel k is inactive.

The central device 10 then proceeds to step 104, where it begins the Wi-Fi channel rating degradation process. First, at step 104, the central device 10 determines the time tₖ^{WiFi} since the channel activity rating Rₖ^{WiFi} was last degraded for Wi-Fi channel k. If the time since the last degradation tₖ^{WiFi} is greater or equal to configurable interval tᵢₙₜₑᵣᵥₐₗ^{WiFi}, the central device 10 proceeds to step 105, where it degrades the channel activity rating Rₖ^{WiFi} by a configurable value W according to the equation:

Rₖ^{WiFi}=Rₖ^{WiFi}×W, (3)

wherein 0<W<1, before proceeding to step 106 where it resets the time since the last degradation for Wi-Fi channel k back to zero. The central device 10 then proceeds to step 106, where it proceeds to the next iteration k=k+1 of the frequency hopping algorithm. If, at step 104, the central device 10 determines that tₖ^{WiFi}<tᵢₙₜₑᵣᵥₐₗ^{WiFi}, the central device instead proceeds directly to step 106 where it proceeds to the next iteration k=k+1 of the Wi-Fi detection algorithm. The central device 10 then returns to step 90.

By performing the Wi-Fi channel degradation process outlined above, each Wi-Fi channel activity rating Rₖ^{WiFi} decreases over time, meaning that if an active Wi-Fi channel becomes inactive after being active for a period of time and thus stops causing interference, its dynamic Wi-Fi channel activity rating Rₖ^{WiFi} will decrease accordingly regardless of whether or not the dynamic channel ratings Rₙ for each BLE channel with overlapping frequency bands has been updated based on packet reception recently.

As is described below the Wi-Fi channel activity ratings are used to determine whether to remove all of the associated BLE channels 40 from the channel map.

It will be understood by those skilled in the art that the process illustrated in FIG. 6 and described above is not limited to Wi-Fi channels, but may be used to determine an estimate of activity levels (and therefore potential interference) of any communication protocol known to use frequency bands that overlap with the BLE channels available to the central 10 and peripheral device 12. It will be also understood by those skilled in the art that although in this example it is the central device 10 that determines whether Wi-Fi channels are active and assigns the dynamic Wi-Fi channel ratings Rₖ^{WiFi}, in other embodiments the peripheral device 12 could perform the Wi-Fi detection algorithm using a similar process and communicates the results to the central device 10 via transmitted data packets.

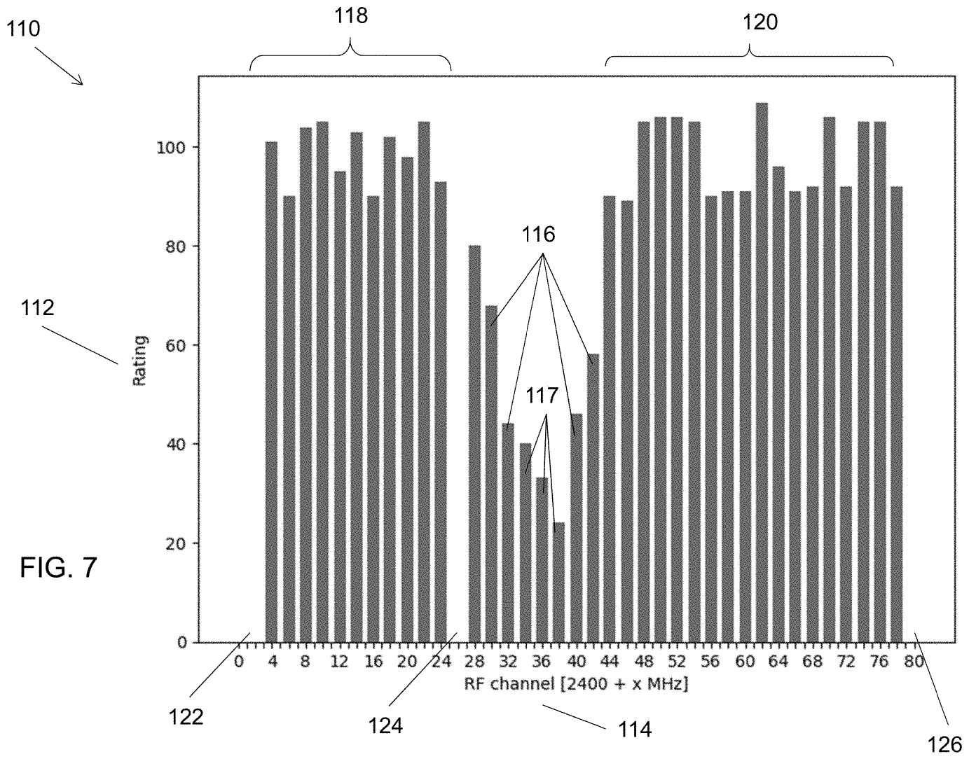

FIG. 7 shows an example of a typical BLE channel rating scenario as determined by the central device 10 using the algorithm outlined above. Shown is a graph 110 of dynamic channel rating 112 (y-axis) against channel frequency 114 (x-axis). The dynamic channel rating 112 is unitless, and the channel frequency 114 is in units of (2400+x) MHz. Typically, the BLE channels have a bandwidth of 1-2 MHz. As can be seen from the graph, the channel ratings 116, 117 are significantly lower than the other channel ratings 118 and 120. No channel ratings are assigned to channels 122, 124 and 126 as these are advertising channels and not data channels, as shown in FIG. 3.

The channel ratings shown in graph 110 are a typical example when the central 10 and peripheral 12 are in the presence of a Wi-Fi network, wherein a single Wi-Fi channel is active. Wi-Fi channels typically have a bandwidth of 22 MHz. The channel ratings 116 are lower than the average channel rating due to interference from the active Wi-Fi channel preventing successful transmission and reception of data packets over the channels with overlapping frequency bands, thus causing channel ratings 116, 117 to decrease. As can be seen from the graph 110, the BLE channel ratings 117 are lower than the BLE channel ratings 116. This is because, as is typically the case, the BLE channels with frequency bands close to the centre of the frequency band of the active Wi-Fi channel experience the highest levels of interference: the centre frequencies of the Wi-Fi channel have the greatest signal strength and therefore produce the greatest levels of interference.

By using the dynamic channel ratings Rₙ and dynamic Wi-Fi channel activity ratings Rₖ^{WiFi} determined using the algorithms described above, the central device 10 removes poor quality channels from a channel map. The term channel map, as used herein, is used to describe the selection of channels from which the central 10 and peripheral 12 devices may ‘hop’ between when frequency hopping. BLE channels that are removed from the channel map are no longer used by the central 10 and peripheral 12 for transmission of data packets. Updates to the channel map are communicated by the central 10 to the peripheral 12 through transmission of a LL_CHANNEL_MAP_IND packet, as is known in the art.

The channel map update process will now be described with reference to the flowchart shown in FIG. 8.

At step 130 the central device 10 determines which Wi-Fi channels are sufficiently likely to be active using the process outlined above with reference to FIG. 6 to determine respective Wi-Fi channel activity ratings and then comparing these to a threshold. The central device then proceeds to step 132, where it compares the number of channels currently removed from the channel map N with a maximum number of channels that may be removed from the channel map at any one time Nₘₐₓ. The value of Nₘₐₓ may be configurable—e.g. by an application developer. If the central device 10 determines that N<Nₘₐₓ, it proceeds to step 134 where it removes up to Nₘₐₓ−N BLE channels 40 with frequency bands that are associated with the Wi-Fi channel(s) determined to be active. If the value of Nₘₐₓ−N is not large enough to accommodate removing all BLE channels with frequency bands that overlap with the Wi-Fi channel(s) determined to be active, the central device 10 proceeds to step 136. If, at step 132 the central device 10 determines that N≥Nₘₐₓ (i.e. no further channels can be removed) the central device instead proceeds to step 138.

At step 136 the central device 10 compares N and Nₘₐₓ after having possibly removed the BLE channels that overlap with active Wi-Fi channels. If N<Nₘₐₓ still, the central device further removes 10 up to Nₘₐₓ−N BLE channels with ratings that fall below a configurable proportion of the average rating of all available BLE channels. Again, if the value of Nₘₐₓ−N is not large enough to accommodate removing all BLE channels with ratings below the threshold, the central device 10 removes the Nₘₐₓ−N channels with the poorest ratings from the map. The central device then proceeds to step 138.

At step 138, the central device 10 determines which (if any) channels have been removed from the channel map for longer than the configurable timeout tₒᵤₜ. The configurable timeout tₒᵤₜ may be a period of time, or it may be a number of packets received by the central device 10, a number of packets transmitted by the central device 10, a number of packets received by the peripheral 12, a number of packets transmitted by the peripheral 12, or any combination of these. In this example, the configurable timeout tₒᵤₜ is a period of time. Next, the central device 10 proceeds to step 140, where it which of the ‘timed out’ BLE channels were originally removed because they overlapped with a Wi-Fi channel determined to be active. For these channels, the central device then identifies the BLE channel from the removed block which corresponds closest to the centre frequency of the active Wi-Fi channel and returns this to the channel map; the other BLE channels from that block are not removed. By returning only the BLE channel corresponding closest to the centre frequency of a Wi-Fi channel determined to be active to the channel map, the central device 10 saves radio resources in re-evaluating the Wi-Fi channel: it is required only to update the rating on a single BLE channel rather than all of them in order to re-evaluate the Wi-Fi channel, requiring fewer radio resources. This process may be repeated if there are other BLE channels removed because they were overlapping with an active Wi-Fi channel.

The central device then proceeds to step 142, where it returns other timed out BLE channels that were individually removed to the channel map. This may be all such removed channels that meet the timeout criterion, or a limit may be imposed, in which case the ‘oldest’ ones are returned.

At step 144, the central device 10 performs the channel rating process outlined in FIG. 5 but prevents the channels it just returned to the channel map at steps 140 or 142 being removed again for a configurable period tₑᵥₐₗ in order to allow enough time to update the ratings of the returned channels. In this example tₑᵥₐₗ is a length of time, however in other embodiments tₑᵥₐₗ may correspond to a number of packets received by the central device 10, a number of packets transmitted by the central device 10, a number of packets received by the peripheral 12, a number of packets transmitted by the peripheral 12, or any combination of these. After the ratings of the returned channels have been updated, the central device 10 includes them in the determination as to whether or not to remove them from the channel map again using the processes described previously.

The process repeats cyclically by returning to step 130. When determining whether a Wi-Fi channel is active in accordance with FIG. 6, as mentioned above only the returned ‘central’ BLE channel will be used for the determination. If the Wi-Fi channel is found still to be active, the central BLE channel may be removed again at step 134.

In a specific example of the method outlined above, the number of channels that may be concurrently removed from the channel map Nmax=15. Using the algorithms outlined above, the central device 10 determines that a single Wi-Fi channel is active, and subsequently removes ten RF channels from the channel map with frequency bands which overlap with the active Wi-Fi channel. This leaves five channels which the central is able to further remove from the channel map. No further Wi-Fi channels are determined to be active so the central device 10 further removes three individual BLE channels with low channel ratings from the channel map. Thus, thirteen channels of the Nmax=15 maximum are removed from the channel map by the central device 10.

Thus it will be understood by those skilled in the art that the present invention provides the ability for a central 10 or peripheral 12 device to dynamically evaluate the quality of BLE channels and blacklist (remove from the channel map) poor quality channels, without requiring the dedicated use of radio resources to evaluate RF channels by performing, for example, Received Signal Strength Indicator (RSSI) scanning.

1. A digital radio communication system comprising a central device and a peripheral device arranged to operate in accordance with a predetermined communication protocol, wherein the central and peripheral devices are both arranged to:
transmit data packets over a plurality of available radio channels having different frequencies;
receive the data packets transmitted by the other respective device; and
perform data integrity checks on the data packets received; wherein at least one of the central and peripheral devices is arranged to assign a dynamic channel rating to one or more of said radio channels based on an outcome of at least some of the data integrity checks.

2. The radio communication system as claimed in claim 1, wherein the at least one of the central and peripheral devices is further arranged to degrade the rating assigned to at least some channels which have not been improved or deteriorated based on data integrity checks for at least a predetermined interval.

3. The radio communication system as claimed in claim 1, wherein the at least one of the central and peripheral devices is arranged to remove radio channels from a channel map, based on their channel ratings, wherein the channel map comprises a selection of radio channel frequencies available for transmission by the central and peripheral devices.

4. The radio communication system as claimed in claim 3, wherein the at least one of the central and peripheral devices is arranged to compare the rating of each channel to an average rating of at least some of the radio channels in said channel map.

5. The radio communication system as claimed in claim 4, wherein the at least one of the central and peripheral devices is arranged to remove channels that are worse than the average by a predetermined percentage.

6. The radio communication system as claimed in claim 3, wherein the at least one of the central and peripheral devices is arranged to remove up to a maximum number of channels that have the worst ratings.

7. The radio communication system as claimed in claim 3, wherein the central and/or peripheral device is arranged to re-evaluate radio channels that have been removed from the channel map after a predetermined interval by returning said channels to the channel map.

8. The radio communication system as claimed in claim 3, wherein the central is arranged to communicate the channel map to the peripheral.

9. The radio communication system as claimed in claim 3, wherein the central and peripheral devices are arranged to frequency hop between the radio channels provided in the channel map according to a predetermined algorithm.

10. The radio communication system as claimed in claim 1, wherein the at least one of the central and peripheral devices is arranged to:
calculate an average channel rating of all of the radio channels in a channel map;
compare the rating of each individual channel to the average channel rating; and
remove at least one channel having a rating worse that the average channel rating by a predetermined amount from the channel map.

11. The radio communication system as claimed in claim 1, wherein the at least one of the central and peripheral devices is arranged to assess each channel's rating at a recurring interval.

12. The radio communication system as claimed in claim 1, wherein the at least one of the central and peripheral devices is further arranged to modify the rating of one or more channels based on the ratings of channels within a predetermined range of frequencies around said channel.

13. The radio communication system as claimed in claim 1, wherein the at least one of the central and peripheral devices is further arranged to assign a dynamic activity rating to one or more potentially interfering channels based on the channel ratings of channels associated with the potentially interfering channel(s) according to a predetermined association.

14. The radio communication system as claimed in claim 1, wherein the at least one of the central and peripheral devices is further arranged to assign a dynamic activity rating to one or more potentially interfering channels based on the data integrity checks performed on channels associated with the potentially interfering channel(s) according to a predetermined association.

15. The radio communication system as claimed in claim 13, wherein the at least one of the central and peripheral devices is further arranged to determine whether one or more of the potentially interfering channels is/are active based on the activity ratings.

16. The radio communication system as claimed in claim 13, wherein the at least one of the central and peripheral devices is further arranged to remove all of the radio channels associated with a potentially interfering channel from a channel map if the activity rating reaches a threshold.

17. The radio communication system as claimed in claim 16, wherein the at least one of the central and peripheral devices is further arranged to re-evaluate potentially interfering channels that have been removed from the channel map after a predetermined interval by returning only one or more representative channels associated with the potentially interfering channel to the channel map.

18. The radio communication system as claimed in claim 13, wherein assigning a dynamic activity rating to a potentially interfering channel comprises:
calculating a first average channel rating of the radio channels that are associated with the potentially interfering channel,
calculating a second average channel rating of all or the remaining radio channels currently in use; and
comparing the first average channel rating to the second average channel rating.

19. The radio communication system as claimed in claim 18, arranged to strengthen or weaken the dynamic activity rating by an amount dependent on one or more of:
the first average;
the difference between the first and second averages; and
the channel rating of a radio channel associated with the potentially interfering channel.

20. The radio communication system as claimed in claim 18, wherein the at least one of the central and peripheral devices is further arranged to degrade the activity rating assigned to at least one potentially interfering channels which has not been strengthened or weakened for at least a predetermined interval.

21. The radio communication system as claimed in claim 13, wherein the one or more potentially interfering channels comprise Wi-Fi.

22. A digital radio transceiver arranged to operate in accordance with a predetermined communication protocol, wherein the transceiver is arranged to:
transmit data packets over a plurality of available radio channels having different frequencies;
receive data packets transmitted by another digital radio transceiver;
perform data integrity checks on the data packets received; and
assign a dynamic channel rating to one or more of said radio channels based on an outcome of at least some of the data integrity checks.

23. A method of operating a digital radio communication system comprising a central device and a peripheral device in accordance with a predetermined communication protocol, the method comprising:
both devices transmitting data packets over a plurality of available radio channels having different frequencies;
both devices receiving the data packets transmitted by the other respective device;
both devices performing data integrity checks on the data packets received; and
at least one of the central and peripheral devices assigning a dynamic channel rating to one or more of said radio channels based on an outcome of at least some of the data integrity checks.

24. A method of operating a digital radio transceiver in accordance with a predetermined communication protocol, the method comprising:
transmitting data packets over a plurality of available radio channels having different frequencies;
receiving data packets transmitted by another digital radio transceiver;
performing data integrity checks on the data packets received; and
assigning a dynamic channel rating to one or more of said radio channels based on an outcome of at least some of the data integrity checks.

25. A non-transitory computer readable medium comprising instructions to cause a digital radio transceiver to operate in accordance with the method as claimed in claim 24.
